(19) United States
(12) Patent Application Publication
(10) Pub. No.: US 2022/0058481 A1
(43) Pub. Date: Feb. 24, 2022

(54) ABNORMALITY DETERMINATION APPARATUS, SIGNAL FEATURE VALUE PREDICTOR, METHOD OF DETERMINING ABNORMALITY, METHOD OF GENERATING LEARNING MODEL, METHOD OF TRAINING LEARNING MODEL AND COMPUTER-READABLE MEDIUM

(71) Applicant: TSUBAKIMOTO CHAIN CO., Osaka-shi, Osaka (JP)

(72) Inventor: Takuya Odagaki, Osaka-shi (JP)

(73) Assignee: TSUBAKIMOTO CHAIN CO., Osaka-shi, Osaka (JP)

(21) Appl. No.: 17/274,868

(22) PCT Filed: Sep. 11, 2019
(86) PCT No.: PCT/JP2019/035602

§ 371 Date: Mar. 10, 2021

(30) Foreign Application Priority Data
Oct. 1, 2018 (JP) 2018-186865

(51) Int. Cl. G06N 3/08; G06K 9/62; G06F 17/18

(52) U.S. Cl. CPC G06N 3/08; G06F 17/18; G06K 9/6257

(57) ABSTRACT

Provided is an abnormality determination apparatus. The abnormality determination apparatus, comprises: a storage unit; and a processor in communication with the storage unit. The processor configured to: accept a first signal output from a first sensor related to operation of a power transmission device and a second signal output from a second sensor attached to the power transmission device; determinate an operating condition based on the first signal; predict feature value of the second signal concerning the power transmission device in a normal state depending on the determined operation condition; and determine a presence or absence of an abnormality based on the predicted feature value of the second signal depending on the determined operating condition of the power transmission device and based on an actual feature value of the second signal

### CROSS-REFERENCE TO RELATED APPLICATIONS

This application is the national phase under 35 U. S. C. § 371 of PCT International Application No. PCT/JP2019/035602 which has an International filing date of Sep. 11, 2019 and designated the United States of America.

### FIELD

The present invention relates to an abnormality determination apparatus for determining the presence or absence of an abnormality in a power transmission device, a signal feature value predictor, a method of determining an abnormality, a method of generating a learning model and a learning model.

### BACKGROUND

As a method for detecting an abnormality of a power transmission device such as a chain, a reduction gear, an actuator or the like, a method has often been employed for providing a target to be detected with an accelerometer, a temperature sensor, etc. and determining the presence or absence of an abnormality by comparing the information obtained from the sensors and one or more thresholds previously set.

### SUMMARY

It is natural that the physical quantities obtained from the sensors vary depending on the operating situations such as under suspension, under acceleration or under low speed operation of the power transmission device and depending on the conditions at that time such as the number of rotations and the load thereof.

Thus, abnormality detection is not easy by such a simple method as determining the presence or absence of an abnormality by comparing the obtained information like a measurement value with a threshold.

The present invention is made in view of such circumstances, and an object is to provide an abnormality determination apparatus capable of accurately determining the presence or absence of an abnormality depending on an operating condition, a signal feature value predictor, a method of determining an abnormality, a method of generating a learning model and a learning model.

An abnormality determination apparatus according to the present disclosure comprises: an input unit through which a first signal output from a first sensor related to operation of a power transmission device as a target and a second signal output from a second sensor attached in order to detect an abnormality of the power transmission device are input; an operating condition determination unit that determines an operating condition of the power transmission device based on the first signal; a feature value prediction unit that predicts a feature value of a second signal output from the second sensor concerning the power transmission device in a normal state depending on the operating condition determined by the operating condition determination unit; and a determination unit that determines the presence or absence of an abnormality based on a feature value of a second signal predicted by the feature value prediction unit depending on an operating condition of the power transmission device determined based on the first signal during a determination target period and a feature value of a second signal input through the input unit during the determination target period.

A signal feature value predictor according to the present disclosure comprises: an input unit through which an operating condition of a power transmission device as a target is input; and an output unit that predicts and outputs a feature value of a signal to be output from a sensor attached in order to detect an abnormality of the power transmission device concerning the power transmission device in a normal state depending on an operating condition input through the input unit.

An abnormality determination method according to the present disclosure comprises: inputting a first signal output from a first sensor related to operation of a power transmission device to be targeted and a second signal output from a second sensor attached in order to detect an abnormality of the power transmission device; determining an operating condition of the power transmission device based on the first signal; predicting a feature value of a second signal output from the second sensor concerning the power transmission device in a normal state depending on the operating condition determined; and determining the presence or absence of an abnormality based on a feature value of a second signal predicted depending on an operating condition of the power transmission device determined based on the first signal during a determination target period and a feature value of a second signal input during the determination target period.

A method of generating a learning model according to the present disclosure comprises: by use of a learning model including an input layer through which an operating condition of a power transmission device as a target for abnormality determination is input, an output layer from which a feature value of a signal output from a sensor attached in order to detect an abnormality of the power transmission device is output and an intermediate layer, determining an operating condition of the power transmission device in a normal state; deriving a feature value of a signal output from the sensor corresponding to the operating condition determined; and learning a parameter in the intermediate layer based on an error between a feature value output from the output layer when the determined operating condition is input to the input layer of the learning model and the feature value derived.

A method of generating a learning model according to the present disclosure comprises: storing a feature value prediction model including an input layer through which an operating condition related to operation of a power transmission device as a target for abnormality determination is input, an output layer from which a feature value of a signal output from a sensor attached in order to detect an abnormality of the power transmission device is output and an intermediate layer having been trained using teacher data including a known operating condition of the power transmission device in a normal state and a feature value of a signal output from the sensor concerning the power transmission device in a normal state; accepting an operating condition of the power transmission device during a determination target period and a signal output from the sensor concerning the power transmission device during the determination target period; and retraining the feature value prediction model by teacher data including the operating condition accepted and a corresponding signal.

A learning model according to the present disclosure comprises: an input layer through which an operating condition related to operation of a power transmission device as a target for abnormality determination is input; an output layer from which a feature value of a signal output from a sensor attached in order to detect an abnormality of the power transmission device is output; and an intermediate layer having been trained by using teacher data including a known operating condition of the power transmission device in a normal state and a feature value of a signal output from the sensor concerning the power transmission device in a normal state, and causes a computer to function as comparing a feature value of a signal predicted to be output from the sensor concerning the power transmission device in the normal state that is output from the output layer when an operating condition of the power transmission device determined during a determination target period is provided to the input layer and a feature value of a signal actually output from the sensor concerning the power transmission device during the determination target period.

In the abnormality determination apparatus of the present disclosure, the feature value of a signal predicted to be output during the normal state from the second sensor attached in order to detect an abnormality concerning the operation of the power transmission device is predicted based on the operating condition determined by the first sensor. The feature value of a signal output from the second sensor varies depending on the operating condition, and thus the feature value depending on the variation can be obtained by the prediction. The feature value of a signal actually output from the second sensor is compared with the feature value of a signal predicted depending on the operating condition. If a feature value different from that in the normal state (usual state) appears, it is determined that an abnormality is present. This makes it possible to perform more accurate determination in comparison with a case where the value of the amplitude or frequency of a signal output from the second sensor is simply compared with a preset threshold.

The feature value prediction unit may be used as a predictor that outputs the feature value of a signal predicted to be output when the operating condition is input.

The feature value prediction unit may be achieved by a learning model that outputs the feature value of a signal when an operating condition is input. The learning algorithm of the learning model is preferably supervised learning such as regression analysis, deep learning or the like. The learning model is trained using the feature value of a signal output from the second sensor in combination with the known operating condition as teacher data.

The operating condition may be determined by a leaning model that outputs an operating condition when a signal output from the first sensor for measuring the physical quantity related to the operating condition of the power transmission device is input. This eliminates the need for a special encoder, sensor or the like for determining the operating condition.

The signal output from the second sensor varies depending on the operating situation of the power transmission device. Thus, the feature value is predicted by a different model depending on the operating situation, which enhances the accuracy of the prediction.

The operating situation may also be determined by the learning model that outputs an operating situation when a signal output from the first sensor for measuring the physical quantity related to the operating situation of the power transmission device is input. This eliminates the need for the obtainment of information from the control device for controlling the power transmission device in order to identify the operating situation.

The abnormality determination apparatus, signal feature value predictor, method of determining an abnormality, method of generating a learning model and learning model according to the present disclosure make it possible to accurately determine the presence or absence of an abnormality.

The above and further objects and features will more fully be apparent from the following detailed description with accompanying drawings.

### BRIEF DESCRIPTION OF THE DRAWINGS

FIG. 1 is a block diagram illustrating the configuration of an abnormality determination apparatus according to Embodiment 1.

FIG. 2 is a flowchart illustrating one example of the processing procedure of a method of generating a feature value prediction model.

FIG. 3 is a flowchart showing one example of the processing procedure of determining an abnormality performed by a control unit.

FIG. 4 illustrates an example of the details of the feature value prediction model.

FIG. 5 is a block diagram illustrating the configuration of an abnormality determination apparatus according to Embodiment 3.

FIG. 6 is a flowchart showing one example of the processing procedure of creating an operating condition learning model according to Embodiment 3.

FIG. 7 illustrates an example of the details of the operating condition learning model.

FIG. 8 is a flowchart showing one example of the processing procedure of determining an abnormality using the operating condition learning model.

FIG. 9 is a block diagram illustrating the configuration of an abnormality determination apparatus according to Embodiment 4.

FIG. 10 illustrates an example of a waveform of a signal from a second sensor.

FIG. 11 is a flowchart showing another example of a method of generating a feature value prediction model.

FIG. 12 is a flowchart showing one example of the processing procedure of determining an abnormality by the control unit according to Embodiment 4.

FIG. 13 is a block diagram illustrating the configuration of an abnormality determination apparatus according to Embodiment 5.

FIG. 14 illustrates an example of the waveform of a signal output from a first sensor.

FIG. 15 is a flowchart showing one example of a processing procedure of creating an operating situation determination model according to Embodiment 5.

FIG. 16 illustrates an example of the details of the operating situation determination model.

FIG. 17 is a flowchart showing one example of the processing procedure of determining an abnormality according to Embodiment 5.

FIG. 18 is a block diagram illustrating the configuration of a system including an abnormality determination apparatus according to Embodiment 6.

### DETAILED DESCRIPTION

The present disclosure will be described below with reference to the drawings depicting embodiments.

### Embodiment 1

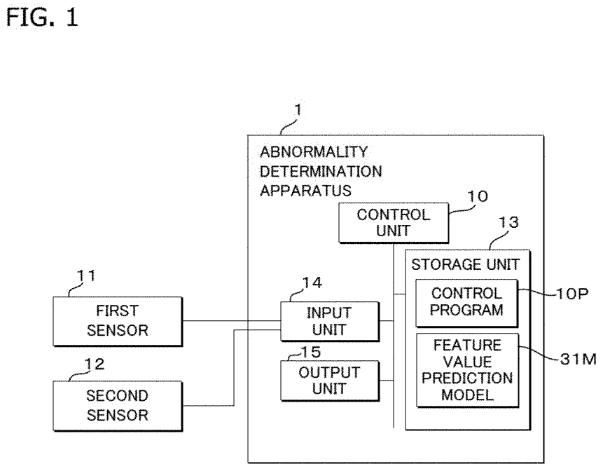

FIG. 1 is a block diagram illustrating the configuration of an abnormality determination apparatus 1 according to Embodiment 1. The abnormality determination apparatus 1 is connected to a first sensor 11 for detecting an operating condition of a power transmission device as a target for abnormality determination and a second sensor 12 for detecting an abnormality of the power transmission device. The abnormality determination apparatus 1 includes a control unit 10, a storage unit 13, an input unit 14 and an output unit 15.

The first sensor 11 is different depending on the type of the power transmission device. The first sensor 11 includes an ammeter for detecting a current value of a motor for driving the power transmission device, a voltmeter for detecting a voltage value and a wattmeter. The first sensor 11 may be any one of them. The speed and the number of rotations (rotational speed) of the power transmission device, a load (loading and weight) applied to the power transmission device, etc. can be determined by the current value, the voltage value and the power value. The first sensor 11 may be an accelerometer.

The second sensor 12 is different depending on the type of the power transmission device. The second sensor 12 may be an accelerometer attached to the power transmission device and detect an abnormality by the magnitude of vibration, the frequency or the like. The second sensor 12 may be a temperature sensor attached to the power transmission device and detect an abnormality by temperature. If the second sensor 12 is a temperature sensor, it may measure the surface temperature of the power transmission device and the ambient air temperature and detect an abnormality by the difference in temperature. Alternatively, the second sensor 12 may employ a sound sensor, a sensor for detecting the turbidity or the like of a lubricant or a magnetometer.

The control unit 10 includes a central processing unit (CPU) or a graphical processing unit (GPU), a memory such as an integrated read only memory (ROM) or a random access memory (RAM), a clock, etc. and controls the components of the abnormality determination apparatus 1. The control unit 10 executes determination processing to be described later based on a control program 10P stored in the integrated ROM or the storage unit 13.

The storage unit 13 employs a nonvolatile storage medium such as a flash memory or the like and rewritably stores information written into or read out by the control unit 10. The storage unit 13 stores a feature value prediction model 31M to be described later and setting information to which the control unit 10 refers other than the control program 10P.

The input unit 14 is an interface through which signals output from the first sensor 11 and the second sensor 12 are input. The input unit 14, which includes an A/D conversion function, may read measurement values from the signals obtained from the first sensor 11 and the second sensor 12 and output the read values to the control unit 10.

The output unit 15 outputs the determination result for an abnormality conducted by the control unit 10. The output unit 15 may output the determination result for an abnormality by light and sound. The output unit 15, which is connected to the power transmission device as a target for determination and the control device of a machine including the power transmission device through a communication line such as a serial communication or the like, may report the determination result for an abnormality to the control device.

The abnormality determination apparatus 1 according to Embodiment 1 uses the feature value prediction model 31M. The abnormality determination apparatus 1 predicts a feature value of a signal output from the second sensor 12 in the normal state based on an operating condition by the use of the feature value prediction model 31M, compares the feature value of a signal actually output from the second sensor 12 with the feature value predicted to be output in the normal state to thereby determine the presence or absence of an abnormality.

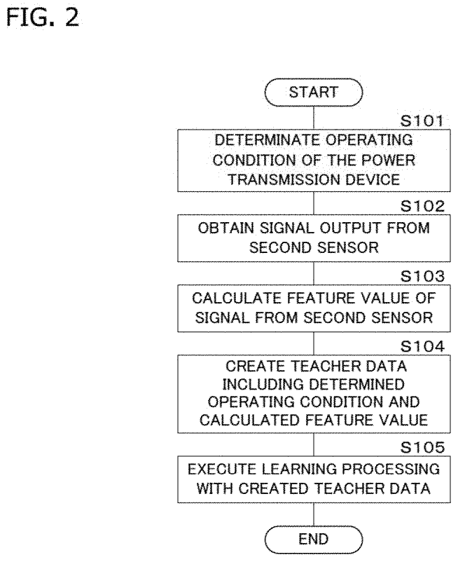

The method of generating the feature value prediction model 31M is described. FIG. 2 is a flowchart showing one example of the processing procedure of a method of generating the feature value prediction model 31M. Learning by means of regression analysis is employed for the learning algorithm of the feature value prediction model 31M according to Embodiment 1. The following processing is executed on a power transmission device that is known to be in a normal and stationary state (under operation in a fixed direction) such as an examined brand-new power transmission device, for example.

The control unit 10 determines an operating condition of the power transmission device (step S101). The operating condition includes the speed and the number of rotations of the power transmission device, the load on the power transmission device, etc. At step S101, the control unit 10 may estimate the operating condition from an average value of the voltage values or the like obtained from the first sensor 11 or may obtain the operating condition from a speed sensor, an accelerometer, an encoder or the like attached to the power transmission device.

The control unit 10 obtains through the input unit 14 a signal output from the second sensor 12 concerning the power transmission device in the operating condition determined at step S101 (step S102) and calculates the feature value of the signal through signal processing (step S103).

The control unit 10 creates teacher data by using the operating condition determined at step S101 and the feature value calculated at step S103 (step S104) and executes learning processing where a function of deriving a feature value is learned using the operating condition as a variable from the teacher data (step S105). The control unit 10 ends the learning during a single sampling timing by the learning processing at step S105.

At step S105, the control unit 10 specifically executes learning processing where a function is learned for defining a relationship between an explanatory variable corresponding to the operating condition and the feature value to be obtained as well as the coefficient of determination. The analysis method such as simple regression, multiple regression, support vector regression, Gaussian process regression or the like may arbitrarily be set according to the operating condition and the feature value. The control unit 10 executes learning of a linear regression equation f (the number of rotations and load) where the vibration effective value (RMS value) actually output from the second sensor 12 as an accelerometer is evaluated assuming that the number of rotations and the load as the operating conditions are variables at step S105, for example. The control unit 10 evaluates the coefficients a_0, a1 and a2 by the regression learning based on the teacher data assuming the linear regression equation is represented as Equation (1).

$$The vibration effective value ( RMS value ) = f ( the number of rotations and load ) = a 0 + a 1 * the number of rotations + a 2 * load \qquad ( 1 )$$

By repetitive execution of the learning processing shown by the flowchart in FIG. 2, the feature value prediction model 31M can be obtained that outputs the feature value of a signal output from the second sensor 12 concerning the power transmission device in the normal state depending on the operating situation. The feature value prediction model 31 M is stored in the storage unit 13 and used in processing for determining an abnormality to be described later.

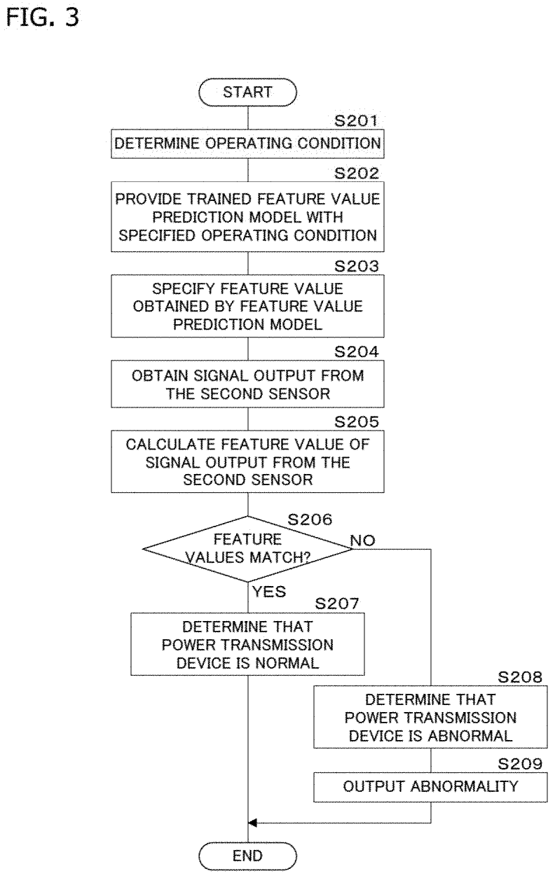

FIG. 3 is a flowchart showing one example of the processing procedure of determining an abnormality performed by the control unit 10. When the power transmission device as a target for determination is put in practice, the control unit 10 executes the following processing at an arbitrary timing in the stationary state (during operation in a fixed direction) based on the control program 10P.

The control unit 10 determines an operating condition of the power transmission device (step S201). The processing performed by the control unit 10 at step S201 is similar to that at step S101 of the flowchart shown in FIG. 2.

The control unit 10 provides the trained feature value prediction model 31M with the operating condition determined at step S201 (step S202) to thereby specify the feature value of a signal obtained by the feature value prediction model 31M (step S203). At step S203, the control unit 10 specifically calculates the vibration effective value (RMS value) by the regression equation using the coefficient of determination obtained by learning.

The control unit 10 acquires through the input unit 14 a signal output from the second sensor 12 at a corresponding timing when the information is obtained from the first sensor 11 at step S201 (step S204), and performs signal processing on the signal to thereby calculate the feature value (step S205). In the example in FIG. 3, the control unit 10 calculates the root-mean-square (rms) value of vibration obtained from the second sensor 12 as an accelerometer at step S205.

The control unit 10 judges whether or not the feature value specified at step S203 matches the feature value calculated at step S205 in a predetermined range (step S206). At step S206, the control unit 10 may make judgement taking into account an error in measurement of the root-mean-square (rms) value.

If it is judged that the feature values match each other at step S206 (S206: YES), the control unit 10 determines that the power transmission device as a target for determination is normal (step S207) and ends the processing.

If it is judged that the feature values do not match each other at step S206 (S206: NO), the control unit 10 determines that the power transmission device as a target for determination is abnormal (step S208), outputs an abnormality from the output unit 15 (step S209) and ends the processing.

In the case where normality is determined for the trained feature value prediction model 31M stored in the storage unit 13, the control unit 10 may execute the processing procedure shown by the flowchart in FIG. 2 using the signal obtained at step S204 to reflect the environment in which the power transmission device is used on the feature value prediction model 31M, which enhances the accuracy of the determination.

This makes it possible to accurately determine the presence or absence of an abnormality based on the information resultantly detected by the second sensor 12 depending on the operating condition without using an encoder or the like for measuring the number of rotations and the load themselves.

The power transmission device includes, for example, chains, especially a general industrial chain, a cable guide and a timing chain for automobile. In the case of the chain, an ammeter for measuring the current value of a motor to move the chain or a wattmeter is used for the first sensor 11 while an accelerometer or a temperature sensor attached to a bearing box or a sprocket is used for the second sensor 12. In the case of the cable guide, a displacement sensor may be used. In these cases, the number of chain links, the number of teeth of the sprocket, the number of strands, etc. may be stored in the storage unit 13 and used in order to determine the operating condition. For the cable guide, the overall length may be stored in the storage unit 13.

Another example of the power transmission device includes a spur wheel, a hypoid gear and a worm gear in the reduction gear. In the case of the reduction gear, a sensor for measuring the current value or the power value of a motor is used for the first sensor 11 while an accelerometer or a temperature sensor attached to a bearing box or a gear box is used for the second sensor 12. In these cases, the numbers of teeth of wheels on the driving side and the driven side as well as an installation direction of a reduction gear are stored in the storage unit 13 in order to determine the operating condition. The operating condition may be evaluated by using the stored ones.

Another example of the power transmission device includes a ball screw and a trapezoidal screw in an actuator. In the case of the actuator, a sensor for measuring the current value or the power value of a motor is used for the first sensor 11 while an accelerometer or a temperature sensor attached to a bearing box or a nut is used for the second sensor 12. In these cases, the installation direction of a ball screw, the direction of load, the overall length, etc. are stored in the storage unit 13 in order to determine the operating condition. The operating condition may be evaluated by using the stored ones.

### Embodiment 2

In Embodiment 2, supervised deep learning using a neural network is employed for the learning algorithm of the feature value prediction model 31M. In the case of the deep learning, a signal is obtained on the time series, and thus a recurrent neural network is more preferable. Alternatively, a long short term memory (LSTM) network may be used.

Since the abnormality determination apparatus 1 of Embodiment 2 is similar in configuration to that of Embodiment 1 except for the detailed processing procedure of the learning processing, common parts are denoted by similar reference codes and detailed description thereof will not be repeated.

In Embodiment 2 as well, the abnormality determination apparatus 1 executes learning processing shown by the flowchart in FIG. 2. The control unit 10 calculates an error between the feature value output from the output layer of the neural network when an operating condition is provided to the input layer of the neural network that is being trained and the feature value of a signal actually obtained from the second sensor 12 to train the parameters in the intermediate layer using back propagation at step S105. For example, an error between the feature value output when the number of rotations and the load as operating conditions are provided to the input layer and the feature value of vibration actually output from the second sensor 12 as an accelerometer is calculated, and the calculated error is propagated. The feature value calculated at step S103 is, for example, the amplitude and the frequency of vibration. The feature value may be a value obtained after statistical processing or the like, such as an average value and a median value, of any one of the amplitude or the frequency. In another example, the feature value is the vibration effective value (RMS value). If the temperature sensor is used for the second sensor 12, the temperature itself may be regarded as a feature value.

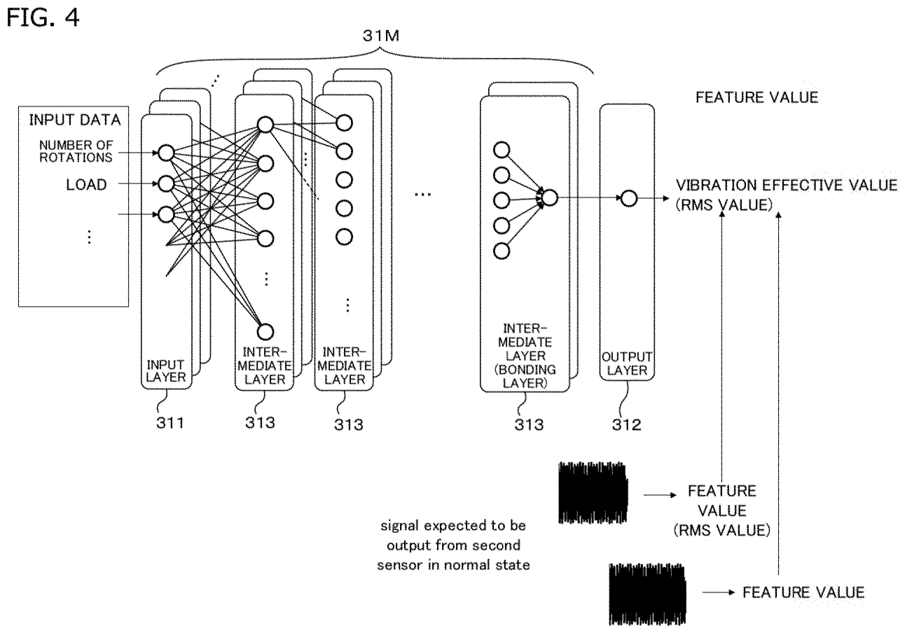

FIG. 4 illustrates an example of the details of a feature value prediction model 31M. The model 31M includes an input layer 311 through which an operating condition of the power transmission device as a target for determination is input and an output layer 312 from which the feature value of a signal expected to be output from the second sensor 12 in the normal state is output. The feature value prediction model 31M using the deep learning includes an intermediate layer 313 that is composed of one or more layers of a group of nodes positioned between the input layer 311 and the output layer 312 and that has been trained by the teacher data of the signal actually output from the second sensor 12 in the normal state as described above.

In the example in FIG. 4, the number of rotations and the load of the power transmission device as operating conditions are input to the input layer 311. The speed of the power transmission device may be input as well. The feature value of a signal expected to be output from the second sensor 12 in the normal state is output from the output layer 312. In the example in FIG. 4, the output layer 312 outputs the vibration effective value (RMS value). Another example of the feature value may include the peak value, the frequency or the like of a signal expected to be output from the second sensor 12 in the normal state.

In Embodiment 2 as well, abnormality determination is performed according to the procedure shown by the flowchart in FIG. 4. The abnormality determination apparatus 1 according to Embodiment 2 provides the input layer 311 of the trained feature value prediction model 31M with an operating condition at step S202 and specifies the feature value of a signal output from the output layer 312 at step S203. If the feature value prediction model 31M shown in the detailed example of FIG. 4 is used, the root-mean-square of vibration in the normal state concerning the operating condition is output and thus assumed as a feature value. The specific value calculated by using the value output from the feature value prediction model 31M may be assumed as a feature value.

The control unit 10 similarly executes the processing at and after step S204, compares the feature value output from the feature value prediction model 31M that has trained by the normal state and the feature value of a signal actually obtained from the second sensor 12, and determines that an abnormality is present (step S208) if they do not match each other (S206: NO).

In Embodiment 2 in which the deep learning is used for the feature value prediction model 31M as well, in the case where normality is determined, the control unit 10 executes the learning processing shown by the flowchart in FIG. 2 using the signal obtained at step S204 to thereby retrain the feature value prediction model 31M. This makes it possible to reflect the environment in which the power transmission device is used on the feature value prediction model 31M to thereby enhance the accuracy of the determination.

### Embodiment 3

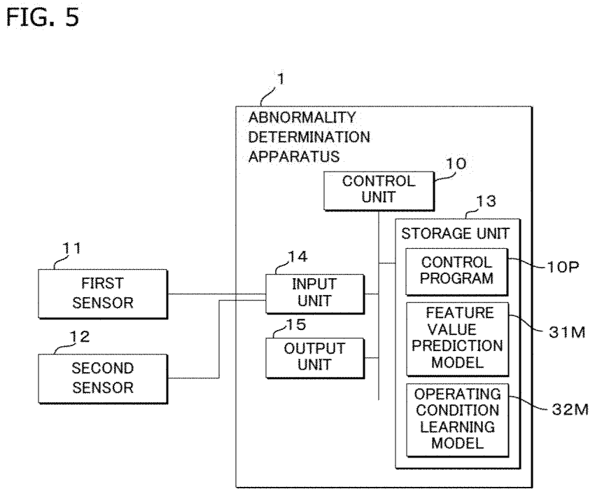

In Embodiment 3, the operating condition is also predicted based on a signal output from the first sensor 11 using a learning model. FIG. 5 is a block diagram illustrating the configuration of an abnormality determination apparatus 1 according to Embodiment 3. The abnormality determination apparatus 1 according to Embodiment 3 is similar in configuration to that of Embodiment 1 except that an operating condition learning model 32M is stored in the storage unit 13 and the operating condition is determined by the operating condition learning model 32M. Accordingly, common parts to Embodiment 1 are denoted by similar reference codes and detailed description thereof will not be repeated.

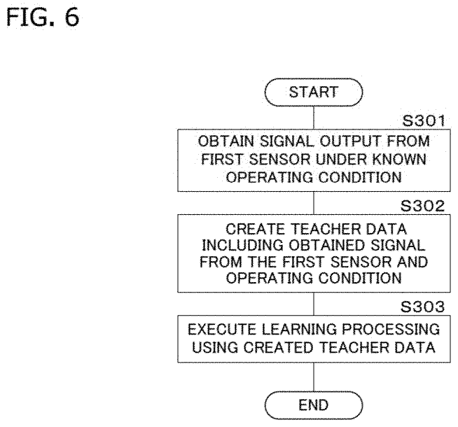

FIG. 6 is a flowchart showing one example of the processing procedure of creating the operating condition learning model 32M according to Embodiment 3. For the learning algorithm of the operating condition learning model 32M, regression analysis may be employed similarly to the feature value prediction model 31M of Embodiment 1 or supervised deep learning using a neural network may be employed similarly to Embodiment 2. In the case where the deep learning is employed, a signal is obtained on the time series and thus, a RNN, especially an LSTM may be used. The following processing is executed on a power transmission device that is known to be in a normal state, for example, an examined brand-new power transmission device.

The control unit 10 obtains a signal output from the first sensor 11 for the power transmission device for which the operating condition has been known (step S301). The control unit 10 creates teacher data including the signal obtained at step S301 associated with the known operating condition (step S302) and executes the learning processing using the created teacher data (step S303). The control unit 10 ends the learning of the signal from the first sensor 11 for which the single operating condition has been known by the learning processing at step S303.

In the case where the control unit 10 executes learning processing by means of regression analysis at step S303, a function of deriving an operating condition to be evaluated and a coefficient of determination are learned assuming that the feature value of a signal from the first sensor 11 is a variable. The feature value is, for example, the frequency of the waveform of a signal output from the first sensor 11, the peak amplitude thereof, the power value after FFT processing or the like. The operating condition is, for example, the number of rotations or a load. In the detailed example, the control unit 10 evaluates by means of the regression analysis coefficients in a regression equation for evaluating the number of rotations using the frequency and the peak amplitude as variables based on multiple teacher data. In the case where the control unit 10 executes learning processing by means of deep learning, the control unit 10 inputs teacher data to the neural network that is being created and learns parameters such as weights and biases in the intermediate layer of the neural network.

By the repetitive execution of the learning processing shown by the flowchart in FIG. 6, the operating condition learning model 32M is created for estimating the operating condition based on a signal from the first sensor 11 or the feature value thereof. The operating condition learning model 32M is stored in the storage unit 13 and used in processing for determining an abnormality to be described later.

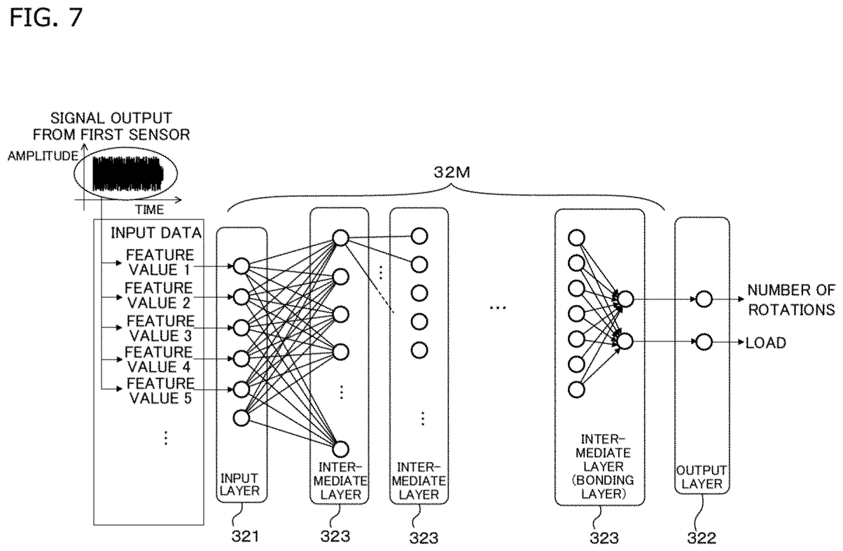

FIG. 7 illustrates an example of the details of the operating condition learning model 32M. The example in FIG. 7 shows a case where deep learning is employed. The operating condition learning model 32M includes an input layer 321 through which multiple feature values of a signal output from the first sensor 11 are input and an output layer 322 from which an operating condition is output. The operating condition learning model 32M includes an intermediate layer 323 that is composed of one or more layers of a group of nodes positioned between the input layer 321 and the output layer 322 and that has been trained by teacher data of a signal output from the first sensor 11 for which the operating condition has been known.

In the example in FIG. 7, feature values obtained from the waveform of a signal output from the first sensor 11 are input to the input layer 321. The feature values may be, for example, the amplitude, the frequency and the statistical values thereof. The output layer 322 outputs a numerical value for each item of the operating condition of the power transmission device that can be estimated from the signal from the first sensor 11. The output layer 322 outputs respective numerical values indicating the number of rotations, the speed and the load, for example. By the use of the operating condition learning model 32, the operating condition can be determined without providing the power transmission device with sensors for directly measuring the operating conditions such as the speed, the acceleration, the number of rotations, etc.

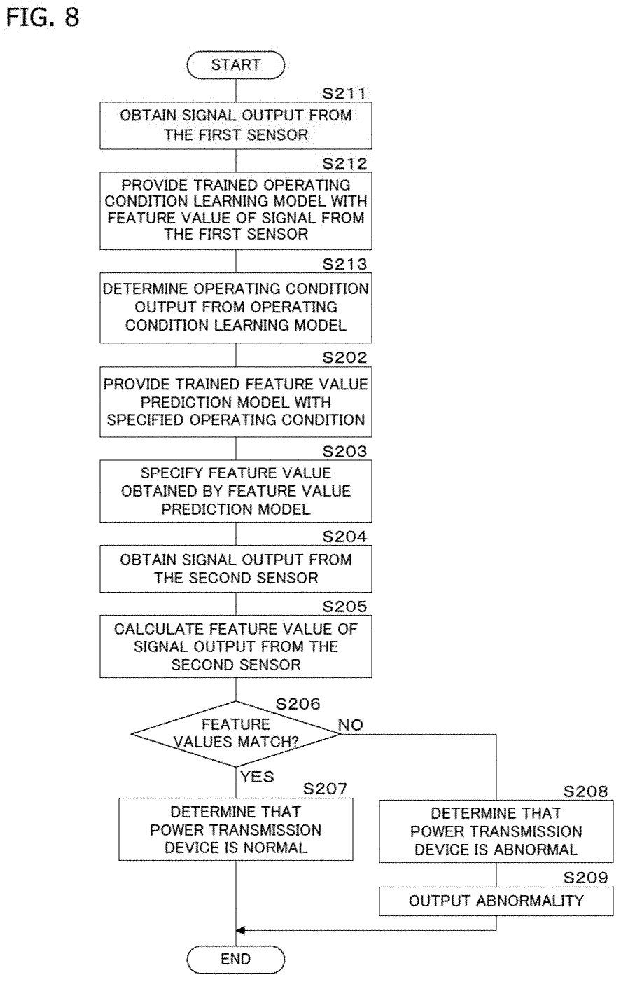

FIG. 8 is a flowchart showing one example of the processing procedure of determining an abnormality using the operating condition learning model 32M. When the power transmission device as a target for determination starts to put in practice, the control unit 10 executes the following processing at an arbitrary timing in the stationary state (during operation in a fixed direction) based on the control program 10P. Of the processing procedure of the flowchart shown in FIG. 8, the processing common to those of the flowchart shown in FIG. 3 in Embodiment 1 are denoted by the same step numbers and detailed description thereof will not be repeated.

Instead of determining the operating condition by arithmetic operation, the control unit 10 acquires a signal obtained from the first sensor 11 (step S211), performs signal processing on the acquired signal to evaluate a feature value and provides the trained operating condition learning model 32M with the feature value (step S212). The control unit 10 determines an operating condition output from the operating condition learning model 32M (step S213), provides the trained feature value prediction model 31M with the operating condition (step S202) and executes the processing at and after step S203.

This makes it possible to accurately estimate the operating condition from the information that can be relatively easily read such as a current value or the like in the motor for driving the power transmission device without providing the power transmission device with a speed sensor, an accelerometer, an encoder or the like to directly obtain the operating condition therefrom.

### Embodiment 4

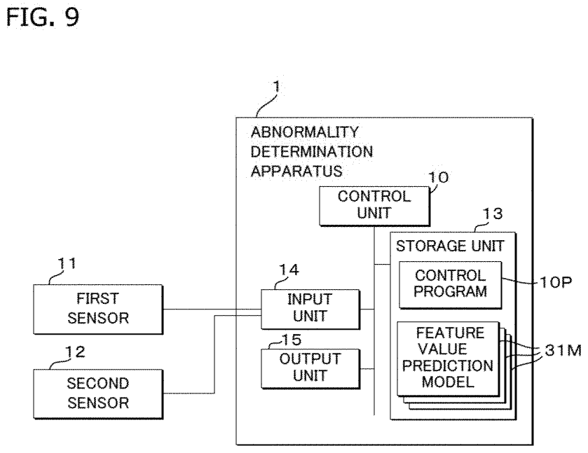

The feature of a signal obtained from the second sensor 12 for detecting an abnormality may be varied even under the same operating condition depending on the operating situation of the power transmission device, such as start and acceleration, in operation at a fixed speed, under deceleration, up-down motion and forward-backward motion. In Embodiment 4, models are used depending on the operating situation. FIG. 9 is a block diagram illustrating the configuration of an abnormality determination apparatus 1 according to Embodiment 4. The abnormality determination apparatus 1 according to Embodiment 4 is similar in configuration to that of Embodiment 1 except that multiple feature value prediction models 31M are stored in the storage unit 13. Accordingly, common parts to Embodiment 1 are denoted by similar reference codes and detailed description thereof will not be repeated.

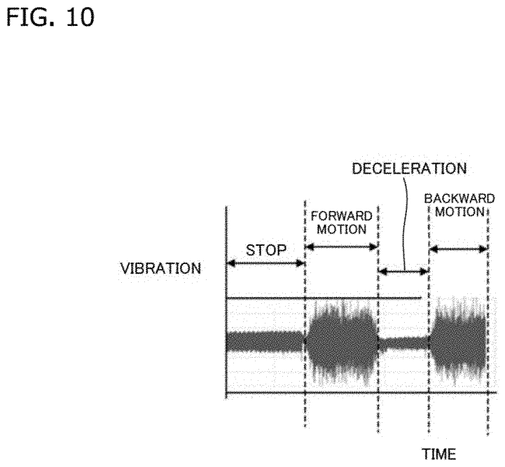

FIG. 10 illustrates one example of the waveform of a signal output from the second sensor 12. In the example shown in FIG. 10, the second sensor 12 is an accelerometer. In FIG. 10, the horizontal axis represents time course while the vertical axis represents vibration. As shown in FIG. 10, the feature value of a signal output from the second sensor attached in order to detect an abnormality is different depending on the operating situation. Accordingly, the feature value prediction model 31M is preferably trained in accordance with the operating situation.

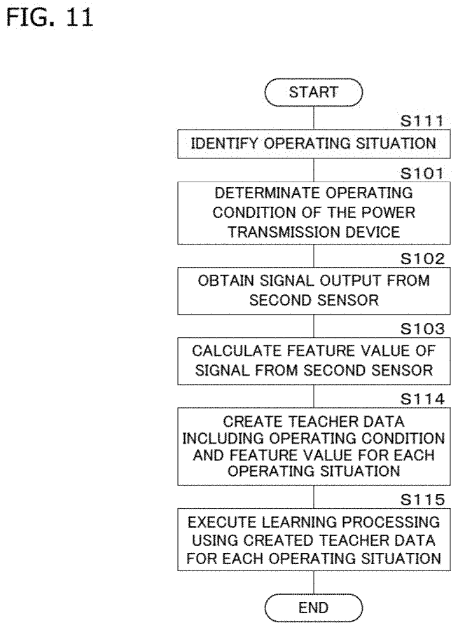

FIG. 11 is a flowchart illustrating another example of the method of generating the feature value prediction model 31M. The operating situation is assumed to be obtained by receiving a signal input from control equipment of the motor of the power transmission device or is assumed to have been known in advance as a test signal. Alternatively, the operating situation may be identified from the feature value such as the vibration frequency, amplitude or the like obtained after signal processing is performed on a signal output from the first sensor 11. Of the processing procedure of the flowchart shown in FIG. 11, the processing common to those of the flowchart shown in FIG. 2 in Embodiment 1 are denoted by the same step numbers and detailed description thereof will not be repeated.

The control unit 10 has identified an operating situation of the power transmission device (step S111), determines an operating condition (step S101), obtains a signal from the second sensor 12 (step S102) and calculates the feature value (step S103).

The control unit 10 creates teacher data composed of the operating condition determined at step S101 and the feature value calculated at step S103, for each operating situation identified at step S111 (step S114). The control unit 10 executes learning processing where coefficients in the model classified by each operating situation or parameters in the neural network are learned using the created teacher data (step S115).

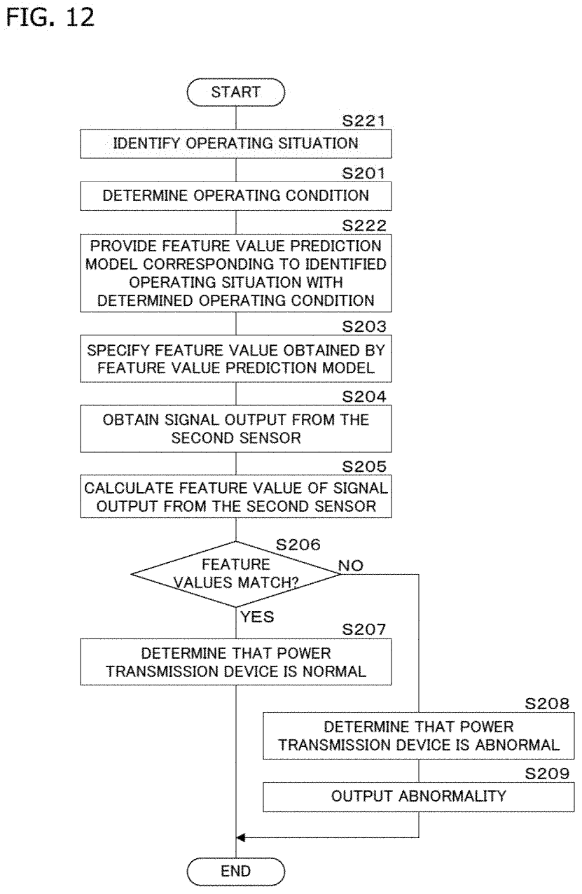

The feature value prediction model 31M is thus created for each operating situation and stored in the storage unit 13 as illustrated in FIG. 9. FIG. 12 is a flowchart showing one example of the processing procedure of determining an abnormality by the control unit 10 according to Embodiment 4. The control unit 10 constantly or periodically executes the following processing based on the control program 10P when the power transmission device as a target for determination starts to put in practice. Of the processing procedure shown by the flowchart in FIG. 12, the processing common to those of the flowchart shown in FIG. 3 in Embodiment 1 are denoted by the same step numbers and detailed description thereof will not be repeated.

The control unit 10 identifies an operating situation of the power transmission device (step S221) and provides, when an operating condition is determined (step S201), the input layer 311 of the feature value prediction model 31M corresponding to the operating situation identified at step S221 with the determined operating condition (step S222). The control unit 10 specifies the feature value of a signal expected to be output from the second sensor 12 in the operating situation output from the feature value prediction model 31M in the normal state (step S203), determines whether or not the specified feature value and a feature value of the signal actually output (steps S204 and S205) match each other (step S206) to thereby determine the presence or absence of an abnormality.

By utilizing the prediction model for each operating situation, abnormality determination can be made depending on the situation, not only for the power transmission device that is moving at a fixed speed in the stationary state.

The processing of identifying an operating situation may be applied for learning and abnormality determination only under the identified situation. For example, in the processing shown in the flowchart in FIG. 11, the control unit 10 identifies an operating situation of the power transmission device at step S111 to determine whether or not it is in the stationary state. The control unit 10 does not execute the processing at and after step S101 if it is in a state other than the stationary state (moving at a fixed speed) or under acceleration. In this case, in the processing shown in the flowchart in FIG. 12, the control unit 10 identifies the operating situation of the power transmission device at step S221 to judge whether or not it is in the stationary state or under acceleration. If it is in the state other than the stationary state or under acceleration, the control unit 10 does not perform the processing at and after S202. Hence, the processing at and after step S202 may be performed only during the period when determination is made possible after the situation is identified.

The method using the operating condition learning model 32M shown in Embodiment 2 can be applied to determination of the operating condition in Embodiment 4.

### Embodiment 5

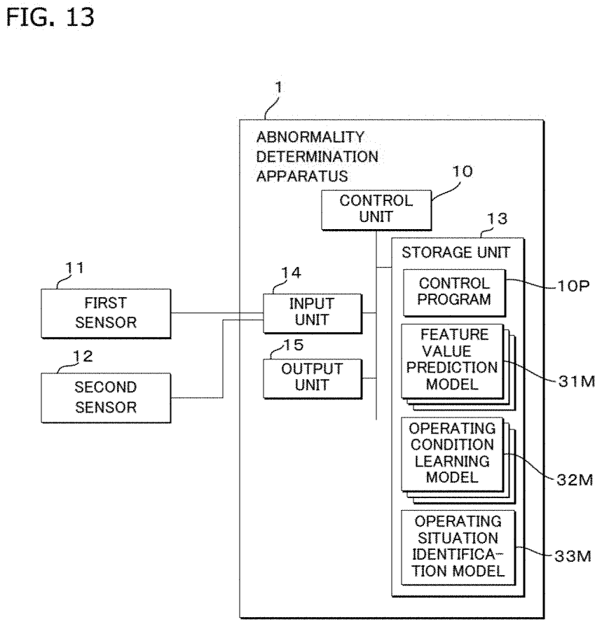

FIG. 13 is a block diagram illustrating the configuration of an abnormality determination apparatus 1 according to Embodiment 5. The abnormality determination apparatus 1 according to Embodiment 5 is similar in configuration to that of Embodiment 1 except that multiple feature value prediction models 31M, multiple operating condition learning models 32M and an operating situation identification model 33M are stored in the storage unit 13, and an operating situation is determined by the operating situation identification model 33M. Accordingly, common parts to Embodiment 1 are denoted by similar reference codes and detailed description thereof will not be repeated.

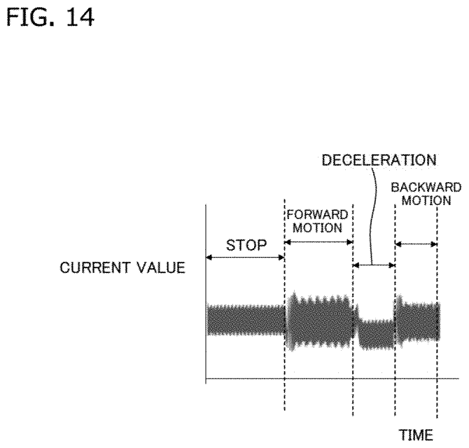

In Embodiment 5, the operating situation is also predicted based on a signal output from the first sensor 11 using a learning model. FIG. 14 illustrates one example of the waveform of a signal output from the first sensor 11. The first sensor 11 is an ammeter in the example in FIG. 14. As illustrated in FIG. 10 in Embodiment 4, in correspondence with the varying waveform of the signal output from the second sensor 12 depending on the operating situation, the current value measured by the ammeter varies depending on the operating situation. Accordingly, even if the operating situation is not obtained from the control equipment of the power transmission device, the operating situation can be predicted and determined by learning of the current value.

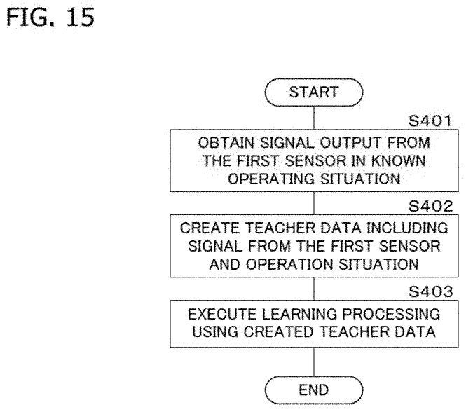

FIG. 15 is a flowchart showing one example of a processing procedure for creating the operating situation identification model 33M according to Embodiment 5. For the learning algorithm of the operating situation identification model 33M, supervised deep learning using a neural network is preferable. A signal is obtained on the time series, and thus a RNN, especially an LSTM may be used. The following processing is executed on the power transmission device in both of the abnormal state and the normal state.

The control unit 10 obtains a signal output from the first sensor 11 concerning the power transmission device in the known operating situation (step S401). The control unit 10 creates teacher data including the signal obtained at step S401 associated with the known operating situation (stop, under acceleration, forward motion, backward motion, under deceleration or the like) (step S402), and executes learning processing of inputting the created teacher data to the neural network and learning parameters such as weights and biases or the like in the intermediate layer of the neural network (step S403). The control unit 10 ends the learning of a single signal output from the first sensor 11 for which the operating situation has been known by the learning processing at step S403.

Repetitive execution of the learning processing shown by the flowchart in FIG. 15 allows the neural network to be the operating situation identification model 33M that identifies the operating situation when a signal from the first sensor 11 is input. The operating situation identification model 33M is stored in the storage unit 13 and used in processing for determining an abnormality to be described later.

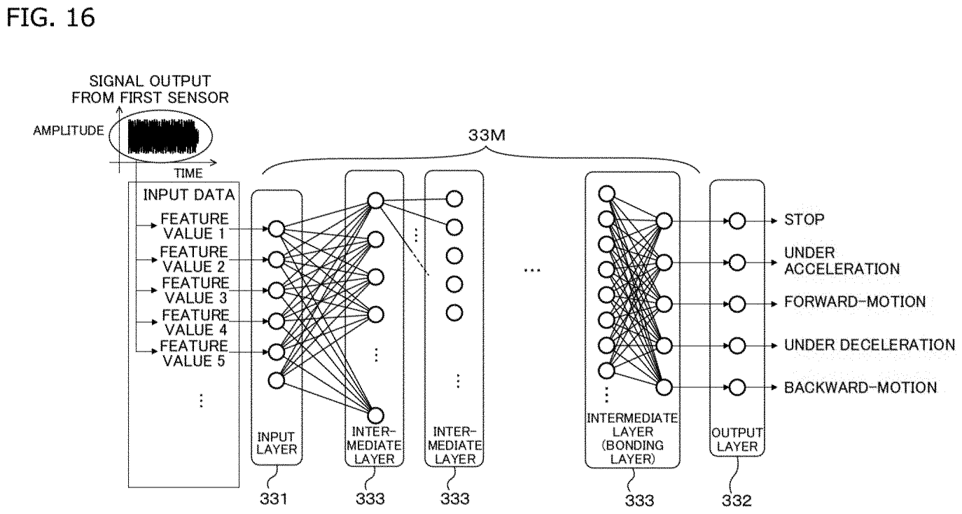

FIG. 16 illustrates an example of the details of the operating situation identification model 33M. The operating situation identification model 33M includes an input layer 331 through which multiple feature values of a signal from the first sensor 11 are input and an output layer 332 from which an operating situation is output. The operating situation identification model 33M includes an intermediate layer 333 that includes one or more layers of a group of nodes that are positioned between the input layer 331 and the output layer 332 and has been trained by the teacher data of a signal from the first sensor 11 for which the operating situation has been known.

In the example in FIG. 16, feature values obtained from the waveform of a signal output from the first sensor 11 are input to the input layer 331. The feature values may be the amplitude, the frequency and the statistic numerical values thereof, for example. The output layer 332 outputs operating situations of the power transmission device that are predicted and identified from the signal from the first sensor 11. The output layer 332 specifically outputs probabilities for different operating situations (stop, under acceleration, forward motion, backward motion, under deceleration, etc.). By the use of the operating situation identification model 33M, the operating situation of the power transmission device can be identified without provision of sensors for directly obtaining and measuring the operating situations of the power transmission device from the control equipment for controlling the power transmission device.

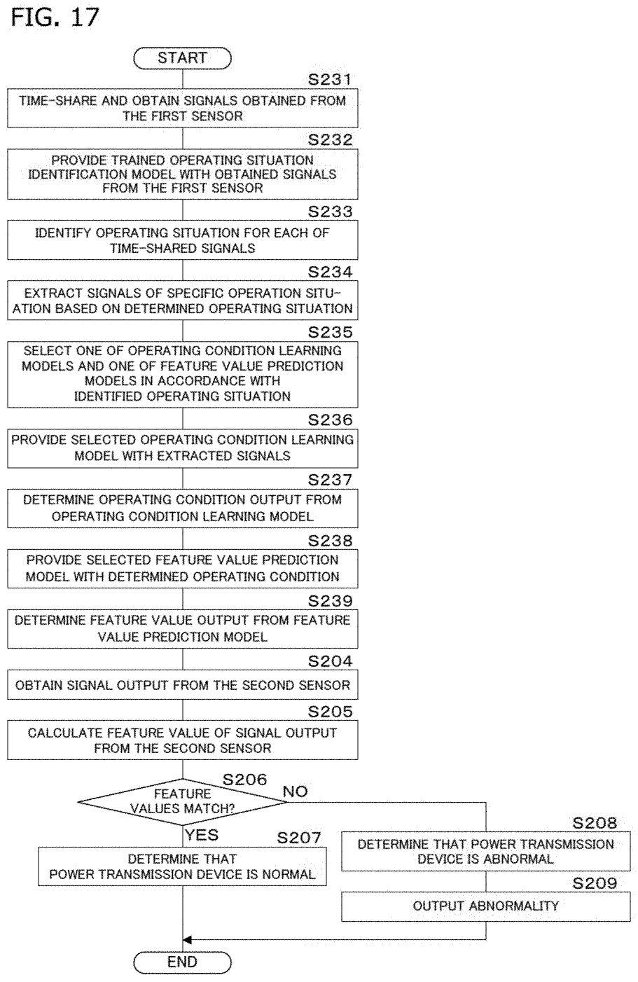

FIG. 17 is a flowchart showing one example of the processing procedure of determining an abnormality according to Embodiment 5. When the power transmission device as a target for determination starts to be put in practice, the control unit 10 constantly or periodically executes the following processing based on the control program 10P. Of the processing procedure of the flowchart shown in FIG. 17, the processing common to those of the flowchart shown in FIG. 12 of Embodiment 4 are denoted by the same step numbers and detailed description thereof will not be repeated.

The control unit 10 time-shares and obtains signals obtained from the first sensor 11 instead of directly identifying the operating situation (step S231) and applies the obtained signals to the input layer 331 of the trained operating situation identification model 33M (step S232). The control unit 10 determines the operating situation output from the operating situation identification model 33M for each of the signals (step S233).

The control unit 10 extracts signals of a specific operation situation (forward motion, for example) based on the determined operating situation (step S234) and selects one of the operating condition learning models 32M and one of the feature value prediction models 31M in accordance with the determined operating situation (step S235).

The control unit 10 provides the operating condition learning model 32M selected at step 235 with the extracted signals (step S236) and determines an operating condition output from the operating condition learning model 32M (step S237). The control unit 10 provides the feature value prediction model 31M selected at step S235 with the determined operating condition (step S238) and determines a feature value output (step S239).

Thereafter, the control unit 10 obtains a signal from the second sensor temporally related to the extracted signal (step S204), calculates the feature value (step S205), determines the presence or absence of an abnormality depending on whether the calculated feature value matches the feature value specified at step S239 (steps S206-S209), and ends the processing.

This makes it possible to accurately estimate the operating condition from the information that can be relatively easily read such as a current value or the like of the motor for driving the power transmission device without obtaining an operating situation from the control equipment of the power transmission device or without directly obtaining the operating condition from a speed sensor, an accelerometer and an encoder having been attached to the power transmission device.

### Embodiment 6

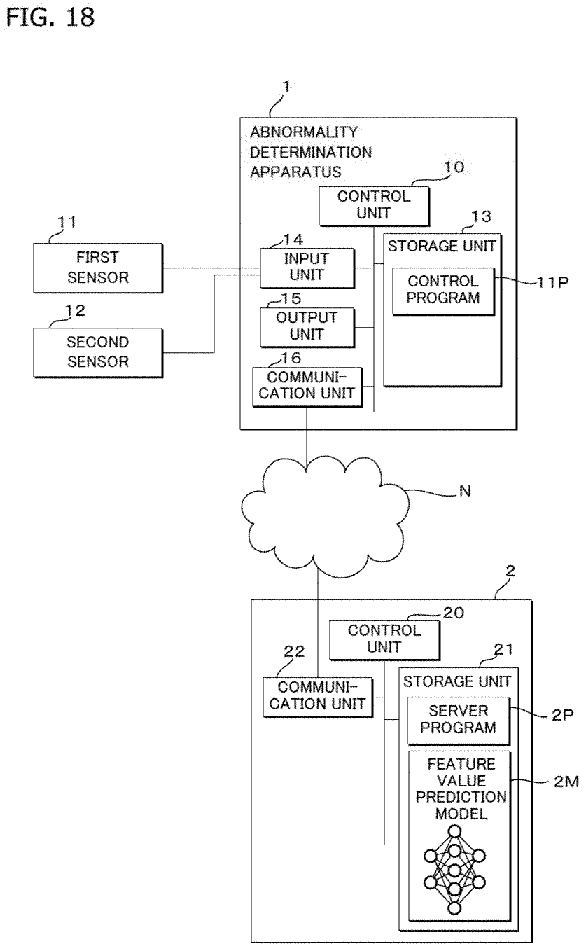

In Embodiment 6, the feature value prediction model 31M is provided from a server device that is communicable with the abnormality determination apparatus 1. FIG. 18 is a block diagram illustrating the configuration of a system including an abnormality determination apparatus 1 according to Embodiment 6. In Embodiment 6 as illustrated in FIG. 18, the abnormality determination apparatus 1 includes a communication unit 16 in addition to the control unit 10, the storage unit 13, the input unit 14 and the output unit 15 and is communicable with the server device 2 via a network N by the communication unit 16.

The network N is the so-called Internet. The network N may include a network provided by a communication carrier that achieves a wireless communication based on a standard such as a next-generation or next-next generation high-speed mobile communication standard.

The server device 2, which employs a server computer, includes a control unit 20, a storage unit 21 and a communication unit 22. The control unit 20, which is a processor using a CPU or a GPU, includes an integrated volatile memory, a clock and the like. The control unit 20 executes each processing based on a server program 2P stored in the storage unit 21 to cause a general-purpose server computer to function as a specific device for creating, updating and using the feature value prediction model 2M.

The storage unit 21 employs a hard disk to store information to which the control unit 20 refers other than the server program 2P. The storage unit 21 stores the feature value prediction model 2M. The server program 2P stored in the storage unit 21 may be acquired from the outside by the communication unit 22 so as to be stored.

The communication unit 22 includes a network card. The control unit 20 can transmit and receive information with a client device 4 via the network N by the communication unit 22.

The feature value prediction model 2M is thus stored in the server device 2. Processing of inputting an operating condition to the feature value prediction model 2M and specifying the feature value is executed by the server device 2 based on the server program 2P. The abnormality determination apparatus 1 can obtain information and perform abnormality determination without performing processing involving heavy arithmetic processing load such as generation and use of the feature value prediction model 31M or the like. Thus, it is possible to use the learning model utilizing abundant hardware resources of the server device 2.

It is to be understood that the embodiments disclosed here are illustrative in all respects and not restrictive. The scope of the present invention is defined by the appended claims, and all changes that fall within the meanings and the bounds of the claims, or equivalence of such meanings and bounds are intended to be embraced by the claims.

It is to be noted that, as used herein and in the appended claims, the singular forms “a”, “an”, and “the” include plural referents unless the context clearly dictates otherwise.

1-12. (canceled)

13. An abnormality determination apparatus, comprising:
a storage unit; and
a processor in communication with the storage unit, wherein
the processor configured to:
accept a first signal output from a first sensor related to operation of a power transmission device and a second signal output from a second sensor attached to the power transmission device;
perform operating condition determination for determining an operating condition of the power transmission device based on the first signal;
perform feature value prediction for predicting a feature value of the second signal concerning the power transmission device in a normal state depending on the determined operation condition; and
determine a presence or absence of an abnormality based on the predicted feature value of the second signal depending on the determined operating condition of the power transmission device from the first signal during a target period and based on a feature value of the second signal during the target period.

14. The abnormality determination apparatus according to claim 13, wherein
the storage unit stores a regression equation to derive a feature value with an operating condition as a variable, the regression equation being previously learned by regression analysis using teacher data, the teacher data including a known operating condition of the power transmission device in a normal state and a feature value of a second signal output from the second sensor for the power transmission device in a normal state, and
the processor predicts a feature value based on the regression equation.

15. The abnormality determination apparatus according to claim 13, wherein
the processor makes a prediction using a feature value prediction model including an input layer through that data corresponding to an operating condition is input, an output layer that outputs a prediction value corresponding to a feature of a second signal to be output from the second sensor and an intermediate layer that has been trained by using teacher data including a known operating condition of the power transmission device in a normal state and a feature value of second signal output from the second sensor concerning the power transmission device in a normal state.

16. The abnormality determination apparatus according to claim 13, wherein
the processor determines a parameter indicating an operating condition by providing an operating condition learning model with data of a first signal output from the first sensor during a target period, the operating condition learning model being learned to output a parameter corresponding to an operating condition of the power transmission device based on the first signal.

17. The abnormality determination apparatus according to claim 13, wherein
the first sensor is a sensor for measuring a current value or a power value of a motor related to the power transmission device and the second sensor is an accelerometer, a temperature sensor or a displacement sensor attached to the power transmission device.

18. The abnormality determination apparatus according to claim 14, wherein
the processor performs respectively leanings of the feature value prediction and the operating condition determination for each operating situation of the power transmission device.

19. The abnormality determination apparatus according to claim 18, wherein the processor performs operating situation identification for identifying an operating situation from data indicating an operating situation, the data being obtained by providing an operating situation identification model with a first signal output from the first sensor during a target period, the an operating situation identification model being learned to output data indicating an operating situation of the power transmission device based on the first signal,
the processor determines an operation condition by using the operating condition learning model learned for each operating situation, and
the processor predicts a feature value by using the feature value prediction model learned for each operating situation.

20. A signal feature value predictor comprising a processor configured to: accept data indicating an operating condition of a power transmission device as a target; and
predict and output a feature value of a signal to be output from a sensor attached to a power transmission device depending on the accepted operating condition, the signal being output from the power transmission device in a normal state.

21. A method of determining an abnormality comprising:
accepting a first signal output from a first sensor related to operation of a power transmission device as a target and a second signal output from a second sensor attached to the power transmission device;
determining an operating condition of the power transmission device based on the first signal;
predicting a feature value of a second signal output from the second sensor concerning the power transmission device in a normal state depending on the operating condition determined; and
determining a presence or absence of an abnormality based on a predicted feature value of a second signal depending on an operating condition of the power transmission device determined from the first signal during a target period and based on an actual feature value of a second signal accepted from the second sensor during the target period.

22. A method of generating data of a learning model comprising:
by use of a learning model including an input layer through which data corresponding to an operating condition of a power transmission device as a target for abnormality determination is input, an output layer outputting a feature value of a signal output from a sensor attached to the power transmission device and an intermediate layer,
determining an operating condition of the power transmission device in a normal state;
deriving a feature value of a signal output from the sensor corresponding to the operating condition determined; and
learning a parameter in the intermediate layer based on an error between a feature value output from the output layer when the data corresponding to determined operating condition is input to the input layer of the learning model and the feature value derived.

23. A method of training a learning model, comprising:
storing a feature value prediction model including an input layer through which data corresponding to an operating condition related to operation of a power transmission device as a target for abnormality determination is input, an output layer outputting a feature value of a signal output from a sensor attached to the power transmission device and an intermediate layer having been trained using teacher data including a known operating condition of the power transmission device in a normal state and a feature value of a signal output from the sensor concerning the power transmission device in a normal state;
accepting data corresponding to an operating condition of the power transmission device during a target period and a signal output from the sensor concerning the power transmission device during the target period; and
retraining the feature value prediction model by teacher data including the data corresponding to operating condition accepted and a corresponding signal.

24. A non-transitory computer-readable medium storing a computer program configured to cause a processor to determines an abnormality of a power transmission device, wherein
the computer program is associated with a learned model, the learned model being trained to cause the processor to:
accept data corresponding to an operating condition related to operation of the power transmission device; and
output a feature value of a signal output from a sensor attached to the power transmission device,
the learned model having been trained by using teacher data including a known operating condition of the power transmission device in a normal state and a feature value of a signal output from the sensor concerning the power transmission device in a normal state, and
the computer program configured to cause the processor to function as comparing a feature value of a signal predicted to be output from the sensor concerning the power transmission device in the normal state that is output from leaned model when an operating condition of the power transmission device determined during a target period is provided to the learned model and a feature value of a signal actually output from the sensor concerning the power transmission device during the target period.
